(19) United States
(12) Patent Application Publication
(10) Pub. No.: US 2025/0322339 A1
(43) Pub. Date: Oct. 16, 2025

(54) SOLUTION UPGRADE RECOMMENDATION ENGINE

(71) Applicant: SAP SE, Walldorf (DE)

(72) Inventors: Sandhya Hariharan, Bangalore (IN); Lingraj B. Rudrawadi, Bangalore (IN); Syamkumar Rajasekharan Nair, Bangalore (IN)

(21) Appl. No.: 18/632,973

(22) Filed: Apr. 11, 2024

(51) Int. Cl. G06Q 10/0637; G06Q 10/067

(52) U.S. Cl. CPC G06Q 10/0637; G06Q 10/067

(57) ABSTRACT

A system, a method, and a computer program product for solutions recommendations. For example, a computer-implemented method may include receiving a query indicating a request for a change that provides a solution to an existing system; triggering a machine learning model to provide a list of one or more solutions that are responsive to the query; validating the one or more solutions provided by the machine learning model based on a comparison using solutions included in a product master database; preparing a recommended list of solutions, the recommended list prepared based on customer data that is clustered based on a region, a country, a company size, an industry type, and/or a sentiment value; and responding to the query with the recommended list of the one or more solutions. Related systems, methods, and articles of manufacture are also disclosed.

### TECHNICAL FIELD

This disclosure relates to machine learning based solution recommendations.

### BACKGROUND

In today's world, many companies rely on software applications to conduct operations. Software applications deal with various aspects of companies' businesses, which can include finances, product development, human resources, customer service, travel management, and many other aspects. Software applications typically operate from servers (which can be on-premise and/or on a cloud platform). Many computing systems require frequent changes to augment existing functionality.

### SUMMARY

In some embodiments, there is provided a computer-implemented method that includes receiving a query indicating a request for a change that provides a solution to an existing system; triggering a machine learning model to provide a list of one or more solutions that are responsive to the query; validating the one or more solutions provided by the machine learning model based on a comparison using solutions included in a product master database; preparing a recommended list of solutions, the recommended list prepared based on customer data that is clustered based on a region, a country, a company size, an industry type, and/or a sentiment value; and responding to the query with the recommended list of the one or more solutions.

In some implementations, the current subject matter may include one or more of the following optional features. The machine learning model may include a large language model. The query may be received from a user interface at a client device. The query may be received with the region, the country, the company size, and/or the industry type associated with the solution to the existing system. The triggering may include providing a prompt to the machine learning model to provide a list of the one or more solutions responsive to the solution of the query. The process may further include receiving, from the machine learning model, the list of the one or more solutions that are responsive to the query. The validating may further include matching the list of the one or more solutions provided by the machine learning model with the solutions found in the product master database and eliminating from the list any of the one or more solutions that do not have a match in the product master database. The responding may further include having one or more scores for the recommended list of solutions. The one or more scores may each generated using a weighted scoring. The weighted scoring may be based on a similarity score between each of the one or more solutions and the solutions included in a product master database. The weighted scoring may be further based on a frequency of usage of the one or more solutions. The weighted scoring may be further based on a customer sentiment indicating a rating provided by users of the one or more solutions. The customer sentiment is obtained using sentiment analysis obtained from at least one server or website.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing system s, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a system for providing a solution recommendation, in accordance with some embodiments;

FIG. 2A depicts an example of a query for obtaining a solution recommendation, in accordance with some embodiments;

FIG. 2B depicts an example of a query response including a solution recommendation, in accordance with some embodiments;

FIG. 3 depicts an example of a process for generating solution recommendations, in accordance with some embodiments;

FIG. 4 depicts an example of sentiment analysis, in accordance with some embodiments; and

FIG. 5 illustrates an example of a processor-based system, in accordance with some embodiments.

### DETAILED DESCRIPTION

It is often difficult for even an expert user, such as IT professional, to update a current system landscape of a company with new or updated solutions (which refers to software applications, services, products, and/or the like). For example, a user may have an existing system, such as a customer relationship management (CRM) solution, installed but wants to change to a new release or perhaps add another type of solution, such as a travel management (TM) solution, human relations management (HRM) solution, and/or the like. In this example, the complexity of the change may include a multistep process of technical changes and the complexity of selecting from different solutions (e.g., which TM solution or HRM solution is a best fit). In some embodiments, there is provided a machine learning based way to facilitate this change by providing a ML based solution recommendation.

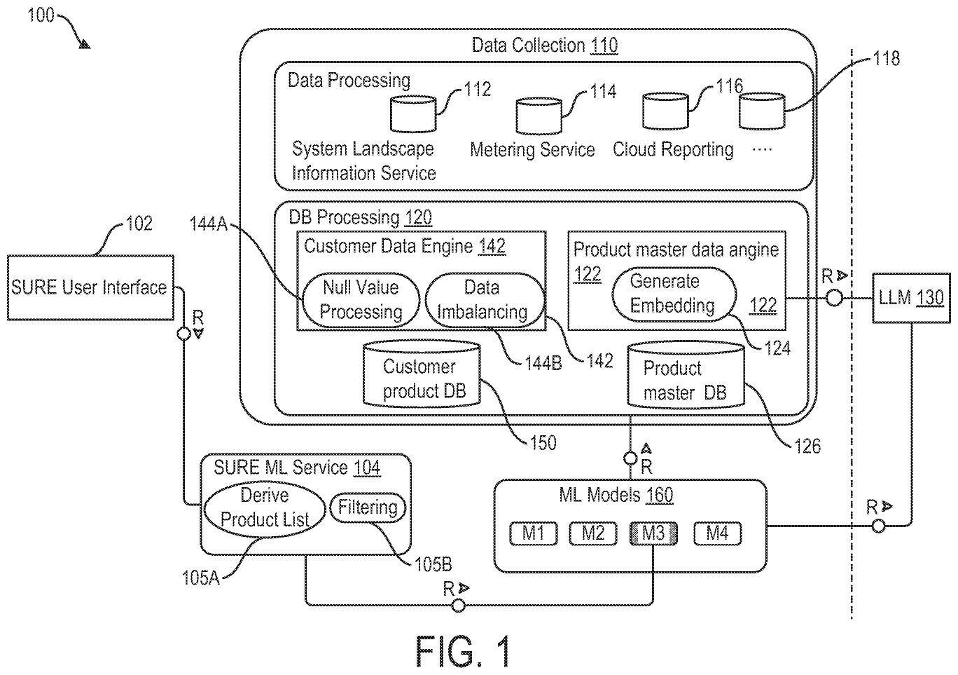

FIG. 1 depicts an example of a system 100 for providing a solution recommendation, in accordance with some embodiments. The system 100 may provide a process for assisting in the change (e.g., an upgrade of an existing solution, a new install of a solution, etc.) to an existing system, such as an enterprise resource planning system (ERP), a CRM, a TM, or any other type of software-based system, by providing at least a recommendation. For example, given an existing system landscape at an enterprise, the recommendation may list one or more solutions in response to an initial query from a user associated with existing system landscape. The recommendations may be based on a machine learning based service. Moreover, the recommendations may be based one or more user requirements, the existing system landscape, a product roadmap, and/or other user feedback (which may be clustered based on one or more factors such as size of enterprise, region associated with the enterprise, industry type of enterprise, and/or the like). For example, the system may provide a list of one or more solutions and a score, which may be in the form of a percentage and may be based on usage by users of the solution(s), feedback from users regarding the solution(s), and the user's existing landscape.

To illustrate further, a user at company A may input a query including requirements of a change, such as “I want to add a Spend Management (SM) solution that includes visualization and planning tools as well.” In this example, the user may also add as part of the query information about company A's industry, company size, country (and/or region). When the query is sent to the system 100, the system may provide a query response. This query response may depict company A's existing landscape (if any) and list one or more solutions in a sorted list (e.g., based on a score, such as a percentage). Each listed solution can be selected to view additional details and components (or subcomponents) of the solution. When a solution is selected from the list, a condensed description of the solution may be generated by the system (e.g., by a machine learning model, such as large language model (LLM) 130 and may be provided to the user.

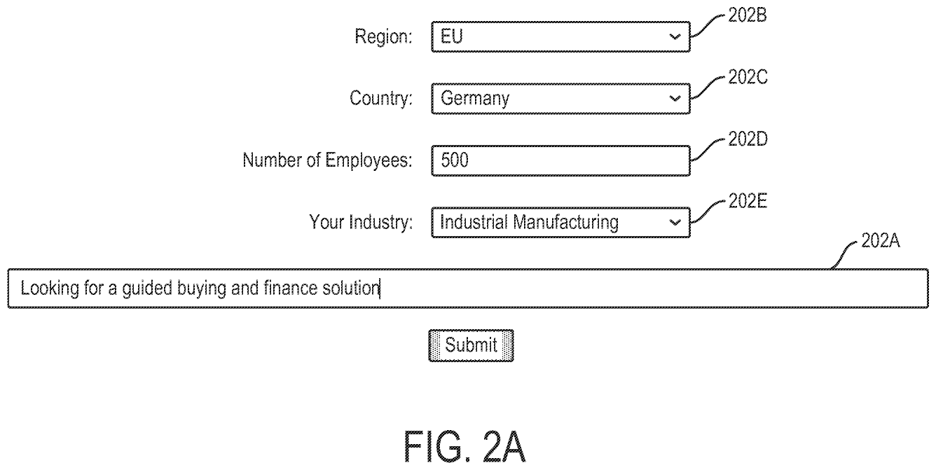

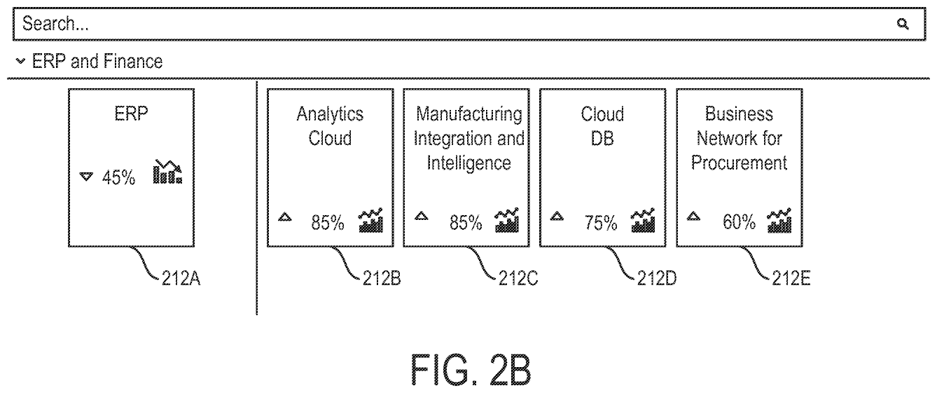

The system 100 may include a solution upgrade recommendation engine (SURE) user interface 102. The SURE user interface 102 (also referred to herein as the user interface 102, for short) may be implemented as an application, service, and/or the like, at which a user may query the system 100 for recommendations regarding solutions. For example, a user may generate a query, such as looking for a guided buying and finance solution. An example of such a query at the SURE user interface 102 is depicted at FIG. 2A. Referring to FIG. 2A, a user provides a query, such as looking for a guided buying and finance solution 202A. The user may also provide as part of the query information about the existing system or enterprise at 202B-E. This additional information may be used by the system 100 to cluster user feedback as explained further below. At FIG. 2A, the user enters a Region 202B indicating where the enterprise is located (e.g., EU), a country 202C indicating in which country the enterprise is located (e.g., Germany), a quantity of employees at the enterprise 202D, a type or category of industry or service associated with the enterprise 202E (e.g., industrial manufacturing, IT, legal, chemical, etc.), and/or other additional information. The user interface 102 may be at a client device, such as a computer, mobile device, and/or the like

Referring again to FIG. 1, the query generated at FIG. 2A for example may be sent from the SURE user interface 102 to the SURE machine learning (ML) service 104 . . . . Although FIG. 1 depicts only a single user interface, a plurality of user interfaces may couple to the system 100 as well.

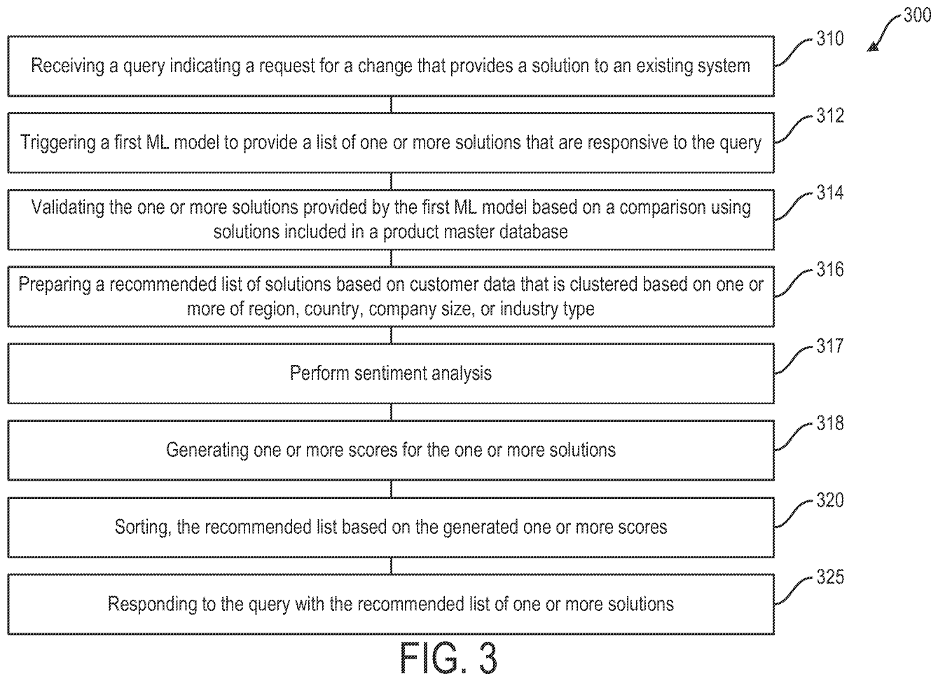

The SURE ML service 104 (also referred to herein as ML service 104, for short) uses machine learning to return one or more recommendations with a score, such as a percentage indicating a “best” match for the query request. The SURE ML service 104 may also provide step by step instructions to implement the change using the recommended solution(s). FIG. 2B depicts an example of the solutions returned from the SURE ML service 104 in response to the query of FIG. 2B. The response shows 5 solutions 212A-E are recommended, and each solution is provided with a corresponding score (shown as a percentage). In the example of FIG. 1, the ovals 105A-B represents one or more ML models, such as model M3 executed at runtime to provide the aspects noted below with respect to 312-318 at FIG. 3, for example.

The system 100 may also include data collection 110. The data collection 110 may include a system landscape information service 112, which may provide information regarding different products (e.g., solutions). The system landscape information service represents a view of the customer landscape that includes the types of solutions (e.g., ERP, CRM, HRM, etc.) and the technical details of the associated systems.

To illustrate further, the system landscape may include a plurality of solutions, such as ERP, CRM, financial management (FM), HRM, and/or the like, as well as configuration and other details related to each of the solutions. And, the system landscape information service 112 may include (or provide) a variety of different CRM solutions which may be used to provide CRM to an existing system or a variety of different HRM solutions, for example. In some embodiments, the system landscape information service may include the existing system landscape of the user at the user interface 102 as well as the system landscapes of other users (which may be at for example other companies), in which case the other user's system landscape information may be anonymized or cleansed to remove proprietary or sensitive information associated with the other users.

The data collection 110 may include a metering service 114. The metering service 114 may meter the usage of solutions across users. For example, the metering service may include information regarding the usage of a given solution, such as how often the solution is used (e.g., frequently, infrequently, etc.), the users (e.g., companies) subscribing to a given solution, what regions and/or countries the users of the solution are in, the industry types of the users of the solution, size of the user company for the solution, and/or the like. In some embodiments, the metering service may include metering information of other users (which may be at other companies), in which case the metering information may be anonymized or cleansed to remove proprietary or sensitive information associated with the other users. The metering service may be used to provide an indication of how useful a solution is to a given user. For example, a solution that is rarely used by a user may be less valuable (and warrants a lower relative recommendation or score), when compared to a solution that is used more frequently (and thus warrants a higher relative recommendation or score).

The data collection 110 may include a cloud reporting service 116. The cloud reporting service may include (for a plurality of users) what solutions have been subscribed to as well as information about the users (e.g., region, company size, country, industry type, and/or other information about the users). For example, the cloud reporting service may include for the user at user interface 102 what solutions have been subscribed by that user as well as information about that user (e.g., region, company size, country, industry type, and/or other information about the user). Likewise, the cloud reporting service may include what solutions have been subscribed and user information for other users (e.g., other users at other companies), in which case the other user's information may be anonymized or cleansed to remove proprietary or sensitive information associated with the other users.

The data collection 110 may include other information 118, such as user feedback about each solution. For example, a user's feedback about a given solution may be captured from electronic surveys, customer review data, third party websites (or servers), and/or the like and then stored in a database.

The data collection may also include database processing 120. The database processing may provide processing and pre-processing of some of the data in the data collection. For example, the database processing 120 may include a product master data engine 122 that cleanses any user (e.g., customer) specific information and anonymizes the data. Moreover, the product master data engine 122 may generate embeddings 124 for the different solutions. For example, the travel management (TM) solution may go by a variety of names, and there may be a variety of different TM solutions. In this example, the labels (e.g., text describing TM solutions or names of TM solutions) have embeddings generated, so the TM solutions have embedding that can be compared and clustered in the numerical space formed by the embeddings. The other solutions would have their embedding generated as well. These embedding are then stored at a product master database 126. In some embodiments, an ML model, such as the large language model (LLM) 130, may be used to generate the embeddings for the solutions.

In the example of FIG. 1, the product master database 126 may be comprised as a vector database. The vector database is a database that stores data as embedding, such as a mathematical representation or vector. When the vector database is used, the embedding in the vector may be clustered and compared using a distance (also referred to as a similarity metric). Based on a similarity measure, a machine learning model may cluster the embedding stored in the vector database into groups, find other embeddings that are similar to a given query embedding, and/or the like. To illustrate further, the product master database 126 may be used to find all TM solutions responsive to a query from the user interface 102 or a query from the LLM 130 (in this example, the TM solutions may be identified as similar as they form a cluster based on a similarity metric). Likewise, if the user interface 102 requests an HRM solution, the product master database 126 may be used to find all HRM solutions based on a similarity metric.

The database processing 120 may also include a customer data engine 142. The customer data engine captures information from users about a solution and stores the information in a database, such as the customer product database 150. For example, the customer data engine 142 may obtain data from the metering service 114 (e.g., usage of solutions across users, usage of a given solution, how often a solution is used (e.g., frequently, infrequently, etc.), users (e.g., companies) subscribing to a given solution, what regions and/or countries the users of a solution are in, industry types of the users of the solution, size of the user company for the solution, and/or the like). Moreover, the customer data engine 142 may obtain data from the cloud reporting service 116 (e.g., what solutions have been subscribed, information about each user (e.g., region, company size, country, industry type, and/or other information about the user), etc.). Alternatively, or additionally, the customer data engine may obtain survey data, such as feedback from users of a given solution (e.g., evaluation of a solution which may include a rating or score). As some of the noted data/information may be from across different users, the customer data engine 142 may cleanse any user/customer specific information and anonymize that data/information. Moreover, the customer data engine may preprocess the data by for example removing null values 144A, correcting data imbalances 144B (e.g., by normalizing the data), and/or perform other types of preprocessing.

In the example of FIG. 1, the customer data engine 142 stores the collected data in a customer product database 150, which in this example comprises a vector database. The vector database stores the customer related data noted above using embeddings such that customers can be compared and selected based on similarity. For example, users (e.g., customers) may be clustered as similar using a similarity metric. In this example, the customer product database 150 may be queried to identify a cluster of users using a solution A, in region B, country C, company size D, and industry type E.

Supposing for example, the query at FIG. 2A is for an HRM solution for a company in the EU, Germany, with less than 500 employees, and in industrial manufacturing. The customer product database 150 (which in this example comprises a vector database) may be queried to find similar users that use an HRM solution, located in the EU (Germany), with less than 500 employees, and in the industrial manufacturing space. And, the vector database may return the list of products (who are within a threshold value of similarity based on a similarity metric). And, for this list of products, their recommendations for an HRM solution may be used in part to score any solutions identified by the LLM 130 or the product master data engine 122. For example, the product master data engine may identify 4 HRM solutions and these may be scored (and/or ranked) based at least in part on recommendation or evaluation data from the list of products identified from the customer product database 150.

As noted, the product master database 126 and the customer product database 150 may be comprised as one or more vector databases. Although FIG. 1 depicts two separate databases for the product master database 126 and the customer product database 150, a single database, such as a single vector database, may be shared by the product master database 126 and the customer product database 150.

The system 100 depicts a plurality of ML models 160 including for example ML model M1, ML model M2, ML model M3, ML model M4, and so forth. The different ML models may represent different ML models. For example, ML model M1 may weight the solutions recommended at for example FIG. 2B using a different scheme than ML model M2. For example the ML model may represent the combination of pre-processed trained data, hyper parameters, and processing logic. The data for product master data and the customer master data and customer recommendations are trained at regular intervals to get accurate recommendations. The hyper parameters are the weights assigned for customer product data and product description and the sentiment analysis of the product. Based on the verification of the results, the hyper parameters are adjusted to get better recommendations. Multiple models may be generated based on the different combinations of training/testing data and hyper parameters. The most accurate model (based on recommendation score) may then be deployed for the usage of system 100 for the user interaction.

The system 100 may couple to, or include, an ML model, such as the LLM 130. The LLM may be comprised as one or more neural networks (e.g., Generative Adversarial Network (GAN) or other type of neural network) an example of which is the LLM provided by Chat GPT. For example, a product master database having documentation for collection of solution may be used and provided to a LLM, such as LLM 130, to pre-process the data and summarize the documentation for each solution by for example summarizing the usage of every solution (e.g., as embeddings) and stored in a vector database (e.g., product master database 126) as embeddings.

FIG. 3 depicts an example of a process for generating an ML based solution recommendation, in accordance with some embodiments. The description of FIG. 3 also refers to FIGS. 1, 2A, and 2B.

At 310, the process may include receiving a query indicating a request for a change that provides a solution to an existing system. For example, the user interface 102 may be accessed by a user to generate a query of the system 100. The query may be received from a client device (which presents or provides the user interface 102) that couples to system 100 via a network.

Referring to FIG. 2A, the query may include information about a solution, such as “Looking for a guided buying and finance solution” 202 or some other type of query for another solution type. The query may also include (as shown at FIG. 2A) information about the user seeking the solution. This additional information enables the ranking of the solutions in the query response to better match the needs of the user. For example, by using the additional information, such as Region 202B, the country 202C, the quantity of employees at the enterprise 202D, and the type or category of industry or service associated with the enterprise 202E, the solutions may be ranked based on the additional information from other users that are in the same or similar region, country 202C, size, and industry type. The enhanced ranking may thus reduce the need for additional searches for solutions, which reduces processing, memory, and network resources associated with these additional searches.

At 312, the processing may include triggering a first machine learning model, such as the LLM 130, to provide a list of one or more solutions that are responsive to the query. For example, the query when received by the ML service 104 may trigger a first ML model, such as the LLM 130, to provide a list of one or more solutions responsive to the query. Supposing the query of FIG. 2A requests HRM solutions, the ML service 104 may prompt the LLM 130 for a list of HRM solutions. And, the LLM may then respond with a list of HRM solutions.

At 314, the process may include validating the one or more solutions provided by the first ML model based on a comparison using solutions included in a product master database. For example, the first ML model, such as the LLM 130, may return a list of 10 HRM solutions in response to a prompt for HRM solutions (as noted in 312 above). The first ML model, such as LLM 130 (or other processor associated with the data collection 110), may then compare the 10 HRM solutions with solutions in the product master database 126 to find matching solutions. Given the 10 HRM solutions, the product master database 126 may be queried to see if the 10 HRM solutions are found in the product master database. When the product master database 315 comprises a vector database, the product master database may respond with a cluster of similar solutions (e.g., within a threshold amount of the similarity metric) to the 10 HRM solutions. The validating may be validated by eliminating any solutions (which are identified by the first ML model, such as the LLM) that are not found in the product master database. For example, if the LLM identifies solutions A-J but only solutions A-E are found and thus validated in the product master database, the validated list of solutions is only solutions A-E.

At 316, the process may include preparing a recommended list of solutions based on customer data that is clustered based on one or more of region, country, company size, or industry type. After the validation for example, the validated solutions, such as solutions A-E may be further processed based on clustered customer data provided by the customer data engine 142. To illustrate further, the solutions A-E may be scored and/or ranked based on customer data. And, the customer data may be clustered based on region, country, company size, and/or the like as noted above.

In some embodiments, sentiment analysis may be performed at 317 for some of the solutions. For example, the sentiment analysis may be performed by obtaining user feedback about the selected solutions. For example, a server or website may be scrapped to obtain the sentiment regarding the solution by or more users. In a simple use case, a third-party website may be scrapped to obtain ratings for one or more of the selected solutions. This sentiment analysis may be used to score the recommended list of solutions.

In some embodiments, the process may include generating, at 318, one or more scores for the one or more solutions. Supposing for example, the query at FIG. 2A is for an HRM solution for a company in the EU, Germany, with less than 500 employees, and in industrial manufacturing. The customer data used for generating the scores and sorting may be based on “clustered customer data,” which refers to customer data from only those companies considered (based on a similarity metric) to be in the EU, Germany, with less than 500 employees, in industrial manufacturing. It is for this group that the customer data is mined for usage frequency of the solution, customer review data (e.g., ranking or user rating), or other indicators associated with a given solution. Moreover, sentiment analysis for this group may be performed as well. For the clustered group of customers, a score (e.g., a percentage) may be used to rank the validated solutions. For example, the score may be a weighted score, such as solution score=0.70 (frequency of use)+0.3 (user review or sentiment analysis). Alternatively, or additionally, the score may take into account the similarity metric (e.g., a cosine similarity score between the query and a given solution in the vector database), in which case the score may be a weighted score equal to for example 0.5 (similarity metric), +0.30 (frequency of use)+0.2 (user review or sentiment analysis). And, the list of solutions may then be sorted, at 320, based on the scores. For example, the recommended list of solutions may be sorted based on any scores for the solutions of the recommended list. Alternatively, or additionally, the sorting may be in ascending or descending order based on a score.

The following illustrates an example where the score is calculated as follows. First, a similarity score of the product to the query is generated by LLM. For example, there are 3 products (e.g., Prod1, Prod2, and Prod3) that are generated for the query with similarity scores as follows: Prod1 0.9, Prod2 0.87, and Prod3 0.67. Next, these 3 products are then filtered in the customer product database 150 to check usage. Assuming there are 1000 customers in a region who are large companies for example, for each of these products, the usage is calculated as number of customers using the product in that group of 1000, so the usage could be as follows: Prod1 0.8, Prod2 0.6, and Prod3 0.7. Next, for each of these 3 products, a sentiment analysis is also considered, such as Prod1 0.8, Prod2 0.7, and Prod3 0.4. Based on the noted scores, the overall score is determined by using a weightage for each of the factors (e.g., similarity, usage, and sentiment). For example, if the weightage is determined as similarity: 0.8, usage: 0.1, sentiment 0.1, for Prod1 the score is 0.9*0.8+0.8*0.1+0.8*0.1=0.88 (88%). The other scores for Prod2 and Prod3 may be similarly calculated and sorted in for example a descending order for recommendation.

When the score is generated for each of the solutions, such as solutions A-E, a list may be prepared of the recommended solutions, such as solutions A-E (which may be sorted based on the score). In some embodiments, a second ML model, such as the ML model M3 at ML models 160, may be used to score (e.g., based on similarity, usage, and sentiment). Alternatively, or additionally, the second ML model (or other processor or component of system 100) may generate an output comprising the recommended list of solutions (e.g., solutions A-E) sorted based on their score. Alternatively, or additionally, the score may be generated without the second ML model (e.g., using a weighted sum as noted above).

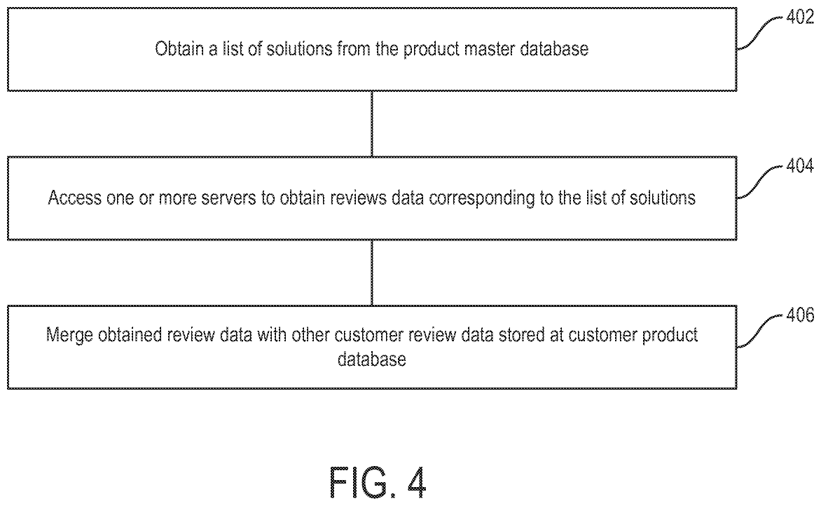

In some embodiments, the customer data may include data mined from sentiment analysis of customer reviews of one or more solutions. In other words, the customer data includes customer review data obtained from a server, such as a third-party server or website. FIG. 4 depicts an example process for obtaining sentiment analysis data. In other words, customer sentiment may provide or indicate a rating provided by users of the one or more solutions, and these rating may be obtained from one or more servers or websites. At 402, a list of solutions may be obtained from the product master database 126. At 404, one or more servers (e.g., websites, databases, etc.) may be accessed to obtain customer review data corresponding to the list of solutions. For example, a third party (or internal) website or database may be access to obtain reviews for solution A stored at the product master database 126. The review data (e.g., surveys, customer reviews, etc.) may include scores, ratings, or other user provided data regarding the solution A. This review data may be fetched. In other words, the ratings, such as 4 out of 5 stars, may be used to provide a sentiment value that takes into account customer sentiment of a solution. At 406, the fetched review data may be merged with other data at system 100. For example, the review data may be merged with other customer data for solution A stored at customer product database 150. For example, if customer (or user) XYZ's customer data regarding solution A is stored at the customer product database 150, the fetched review data from the third-party source may be added to customer XYZ's customer data for solution A. In some embodiments, the sentiment analysis may be performed by a third ML model, such as a convolutional neural network, natural language processing ML model, and/or a GAN (or LLM).

At 325, the process may include responding to the query with the recommended list of one or more solutions. After the sorting, the recommended list of solutions, such as solutions A-E, may be provided by the ML service 104 to the user interface 102. FIG. 2B depicts an example of the recommended list of solutions including scores.

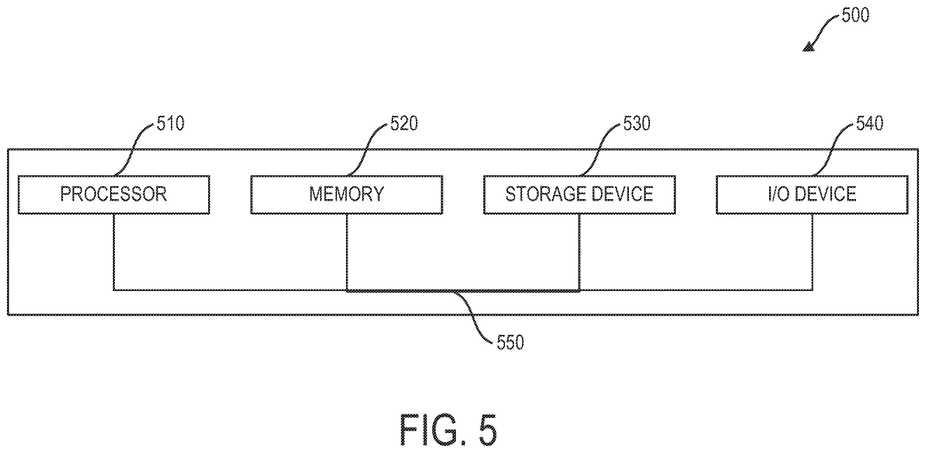

In some implementations, the current subject matter can be configured to be implemented in a system 500, as shown in FIG. 5. The system 500 can include a processor 510, a memory 520, a storage device 530, and an input/output device 540. Each of the components, such as 510, 520, 530 and 540, can be interconnected using a system bus 550. The processor 510 can be configured to process instructions for execution within the system 500. In some implementations, the processor 510 can be a single-threaded processor. In alternate implementations, the processor 510 can be a multi-threaded processor. The processor 510 can be further configured to process instructions stored in the memory 520 or on the storage device 530, including receiving or sending information through the input/output device 540. The memory 520 can store information within the system 500. In some implementations, the memory 520 can be a computer-readable medium. In alternate implementations, the memory 520 can be a volatile memory unit. In yet some implementations, the memory 520 can be a non-volatile memory unit. The storage device 530 can be capable of providing mass storage for the system 500. In some implementations, the storage device 530 can be a computer-readable medium. In alternate implementations, the storage device 530 can be a floppy disk device, a hard disk device, an optical disk device, a tape device, non-volatile solid state memory, or any other type of storage device. The input/output device 540 can be configured to provide input/output operations for the system 500. In some implementations, the input/output device 540 can include a keyboard and/or pointing device. In alternate implementations, the input/output device 540 can include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

Example 1: A computer-implemented method, comprising:
receiving a query indicating a request for a change that provides a solution to an existing system;
triggering a machine learning model to provide a list of one or more solutions that are responsive to the query;
validating the one or more solutions provided by the machine learning model based on a comparison using solutions included in a product master database;
preparing a recommended list of solutions, the recommended list prepared based on customer data that is clustered based on a region, a country, a company size, an industry type, and/or a sentiment value; and responding to the query with the recommended list of the one or more solutions.

Example 2: The computer-implemented method of Example 1, wherein the machine learning model comprises a large language model.

Example 3: The computer-implemented method of any of Examples 1-2, wherein the query is received from a user interface at a client device.

Example 4: The computer-implemented method of any of Examples 1-3, wherein the query is received with the region, the country, the company size, and/or the industry type associated with the solution to the existing system.

Example 5: The computer-implemented method of any of Examples 1-4, wherein the triggering comprises providing a prompt to the machine learning model to provide a list of the one or more solutions responsive to the solution of the query.

Example 6: The computer-implemented method of any of Examples 1-5 further comprising:

receiving, from the machine learning model, the list of the one or more solutions that are responsive to the query.

Example 7: The computer-implemented method of any of Examples 1-6, wherein the validating comprises matching the list of the one or more solutions provided by the machine learning model with the solutions found in the product master database and eliminating from the list any of the one or more solutions that do not have a match in the product master database.

Example 8: The computer-implemented method of any of Examples 1-7, wherein the responding further comprises including one or more scores for the recommended list of solutions.

Example 9: The computer-implemented method of any of Examples 1-8, wherein the one or more scores are each generated using a weighted scoring.

Example 10: The computer-implemented method of any of Examples 1-9, wherein the weighted scoring is based on a similarity score between each of the one or more solutions and the solutions included in a product master database.

Example 11: The computer-implemented method of any of Examples 1-10, wherein the weighted scoring is further based on a frequency of usage of the one or more solutions.

Example 12: The computer-implemented method of any of Examples 1-11, wherein the weighted scoring is further based on a customer sentiment indicating a rating provided by users of the one or more solutions.

Example 13: The computer-implemented method of any of Examples 1-12, wherein the customer sentiment is obtained using sentiment analysis obtained from at least one server or website.

Example 14: A system comprising: at least one processor; and at least one memory including code, which when executed by the at least one processor causes operations comprising:

receiving a query indicating a request for a change that provides a solution to an existing system;
triggering a machine learning model to provide a list of one or more solutions that are responsive to the query;
validating the one or more solutions provided by the machine learning model based on a comparison using solutions included in a product master database;
preparing a recommended list of solutions, the recommended list prepared based on customer data that is clustered based on a region, a country, a company size, an industry type, and/or a sentiment value; and responding to the query with the recommended list of the one or more solutions.

Example 15: The system of Example 14, wherein the machine learning model comprises a large language model.

Example 16: The system of any of Examples 14-15, wherein the query is received from a user interface at a client device.

Example 17: The system of any of Examples 14-16, wherein the query is received with the region, the country, the company size, and/or the industry type associated with the solution to the existing system.

Example 18: The system of any of Examples 14-17, wherein the triggering comprises providing a prompt to the machine learning model to provide a list of the one or more solutions responsive to the solution of the query.

Example 19: The system of any of Examples 14-18 further comprising:
receiving, from the machine learning model, the list of the one or more solutions that are responsive to the query.

Example 20: A non-transitory computer-readable storage medium code, which when executed by at least one processor causes operations comprising:
receiving a query indicating a request for a change that provides a solution to an existing system;
triggering a machine learning model to provide a list of one or more solutions that are responsive to the query;
validating the one or more solutions provided by the machine learning model based on a comparison using solutions included in a product master database;
preparing a recommended list of solutions, the recommended list prepared based on customer data that is clustered based on a region, a country, a company size, an industry type, and/or a sentiment value; and responding to the query with the recommended list of the one or more solutions.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving a query indicating a request for a change that provides a solution to an existing system;
triggering a machine learning model to provide a list of one or more solutions that are responsive to the query;
validating the one or more solutions provided by the machine learning model based on a comparison using solutions included in a product master database;
preparing a recommended list of solutions, the recommended list prepared based on customer data that is clustered based on a region, a country, a company size, an industry type, and/or a sentiment value; and
responding to the query with the recommended list of the one or more solutions.

2. The computer-implemented method of claim 1, wherein the machine learning model comprises a large language model.

3. The computer-implemented method of claim 1, wherein the query is received from a user interface at a client device.

4. The computer-implemented method of claim 1, wherein the query is received with the region, the country, the company size, and/or the industry type associated with the solution to the existing system.

5. The computer-implemented method of claim 1, wherein the triggering comprises providing a prompt to the machine learning model to provide a list of the one or more solutions responsive to the solution of the query.

6. The computer-implemented method of claim 1 further comprising:
receiving, from the machine learning model, the list of the one or more solutions that are responsive to the query.

7. The computer-implemented method of claim 1, wherein the validating comprises matching the list of the one or more solutions provided by the machine learning model with the solutions found in the product master database and eliminating from the list any of the one or more solutions that do not have a match in the product master database.

8. The computer-implemented method of claim 1, wherein the responding further comprises including one or more scores for the recommended list of solutions.

9. The computer-implemented method of claim 8, wherein the one or more scores are each generated using a weighted scoring.

10. The computer-implemented method of claim 9, wherein the weighted scoring is based on a similarity score between each of the one or more solutions and the solutions included in a product master database.

11. The computer-implemented method of claim 10, wherein the weighted scoring is further based on a frequency of usage of the one or more solutions.

12. The computer-implemented method of claim 11, wherein the weighted scoring is further based on a customer sentiment indicating a rating provided by users of the one or more solutions.

13. The computer-implemented method of claim 12, wherein the customer sentiment is obtained using sentiment analysis obtained from at least one server or website.

14. A system comprising:
at least one processor; and
at least one memory including code, which when executed by the at least one processor causes operations comprising:
receiving a query indicating a request for a change that provides a solution to an existing system;
triggering a machine learning model to provide a list of one or more solutions that are responsive to the query;
validating the one or more solutions provided by the machine learning model based on a comparison using solutions included in a product master database;
preparing a recommended list of solutions, the recommended list prepared based on customer data that is clustered based on a region, a country, a company size, an industry type, and/or a sentiment value; and
responding to the query with the recommended list of the one or more solutions.

15. The system of claim 14, wherein the machine learning model comprises a large language model.

16. The system of claim 14, wherein the query is received from a user interface at a client device.

17. The system of claim 14, wherein the query is received with the region, the country, the company size, and/or the industry type associated with the solution to the existing system.

18. The system of claim 14, wherein the triggering comprises providing a prompt to the machine learning model to provide a list of the one or more solutions responsive to the solution of the query.

19. The system of claim 14 further comprising:
receiving, from the machine learning model, the list of the one or more solutions that are responsive to the query.

20. A non-transitory computer-readable storage medium code, which when executed by at least one processor causes operations comprising:
receiving a query indicating a request for a change that provides a solution to an existing system;
triggering a machine learning model to provide a list of one or more solutions that are responsive to the query;
validating the one or more solutions provided by the machine learning model based on a comparison using solutions included in a product master database;
preparing a recommended list of solutions, the recommended list prepared based on customer data that is clustered based on a region, a country, a company size, an industry type, and/or a sentiment value; and
responding to the query with the recommended list of the one or more solutions.
